(19) United States
(12) Patent Application Publication
(10) Pub. No.: US 2007/0192184 A1
(43) Pub. Date: Aug. 16, 2007

(54) Web access control

(76) Inventors: Yigang Cai, Naperville, IL (US); Shiyan Hua, Lisle, IL (US)

Correspondence Address: Werner Ulrich, 434 Maple Street, Glen Ellyn, IL, 60137, US

(21) Appl. No.: 11/353,793

(22) Filed: Feb. 14, 2006

(51) Int. Cl. G06Q 30/00

(52) U.S. Cl. 705/14

(57) ABSTRACT

This invention relates to a method and apparatus for controlling user access to websites. A user profile is stored for each user. The profile includes a restriction requirement. Each accessible website has an associated restriction rating. If a user tries to access a website, the restriction requirement of the user is compared with the restriction rating of the website; access is only allowed if the result of the comparison indicates that access is allowable. Advantageously, this arrangement permits users to define the restriction requirement to be met by the restriction rating of websites to which the user is allowed access.

### TECHNICAL FIELD

This invention relates to a method and apparatus for controlling access to different websites on the Internet.

### BACKGROUND OF THE INVENTION

The Internet gives customers connected to an Internet service provider access via the Internet to a multiplicity of different websites. The websites can accept commands from the customer store data such as the data associated with customer purchases, and deliver content back to the customer such as text or video.

A problem of the prior art is that there is no good way of controlling access to different websites including websites offering video or text that is unsuitable for children/teenagers.

### SUMMARY OF THE INVENTION

Applicants have carefully studied this problem and have concluded that what is required is a system for controlling access to individual websites based on a customer profile of the requesting customer and a content restriction rating of each accessible website. Accordingly, Applicants have made a contribution over the teachings of the prior art in accordance with their invention wherein an Internet service provider comprises or has access to a database containing a user profile for each customer and an access restriction rating for each website; when a customer provides the URL (Uniform Resource Locator) or file name, the Internet service provider checks whether the restriction rating of the requested website is consistent with the restriction requirement of the requesting customer, if the restriction requirement and the restriction rating of the website are consistent, i.e., the restriction rating is within the limits allowed for the requesting customer, then the connection to the website can be established; otherwise it is blocked. Advantageously, different customers with different restriction requirements permit different customers to have access to different subsets of the set of websites accessible via the Internet.

In accordance with one aspect of the invention, different users from one terminal are identified by different logins so that, for example, a child user can be identified by the Internet service provider and distinguished from an adult user that owns a primary account/login. Advantageously, the access to the websites can be differentially controlled for different users of one terminal by associating different user profiles with different logins of a particular customer terminal.

In order to implement Applicants' invention each website must have an associated restriction rating. In accordance with one feature of Applicants' invention a website can have a plurality of restriction ratings each associated with a different subset of the content stored in the website. Each subset is identified by a different URL. Then if the Internet service provider transmits the restriction code for the requester, the Internet service provider can determine whether or not the request accompanying the access message can be honored. Advantageously, a single website can contain a plurality of restricted content levels.

In accordance with another feature of Applicants' invention, a restriction requirement can include a time of day and/or day of the week restriction. Advantageously, for example, access to games provided on a website can be denied to the children or teenagers of the household after a bedtime limit.

In accordance with one feature of Applicants' invention, the ability to change the user profile of an account is restricted to one or more selected logins of a particular customer. Advantageously, for example, only the parents can change the restriction privileges of their children and not vice versa.

In accordance with another feature of Applicants' invention, a global restriction list can be provided so that no user of a particular Internet service provider, with the possible exception of a suitably privileged government user, can access certain websites. Advantageously, particularly obnoxious websites cannot be accessed by any customer of that Internet service provider.

In accordance with one feature of Applicants' invention, the website stores the restriction rating. The absence of a restriction rating is considered to be a default attribute which is that access to the website has no restrictions.

### BRIEF DESCRIPTION OF THE DRAWING

FIG. 1 is a block diagram illustrating the operation of Applicants' invention;

FIG. 2 is a flow diagram illustrating the processing of a web access request from a user; and

FIG. 3 is a flow diagram illustrating the operation of a request from a user to access the user profile.

### DETAILED DESCRIPTION

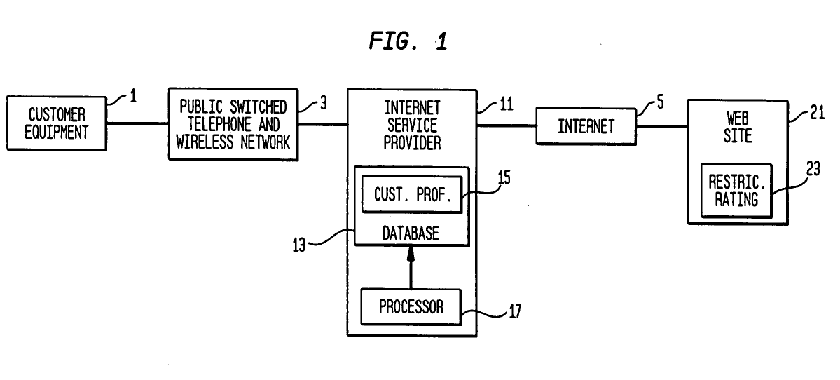

FIG. 1 is a block diagram illustrating the operation of Applicants' invention. A customer at customer equipment 1 is connected via the public switched telephone and wireless network 3 to an Internet service provider 11, and thence to the Internet 5. The customer equipment can be a land line, in which case only the public switched telephone network is used for accessing the Internet, or it can be a wireless terminal, in which case the public switched wireless network is used to access the public switched telephone network, and thence to connect to the Internet service provider. The wireline network can provide access via a 1-800 number, via a digital subscriber line (DSL), via a cable modem. Wireless access can be provided via WiFi (Wireless Fidelity), WiMax (Worldwide Interoperability for Microwave Access), WLAN (Wireless Local-Area Network) or WAP (Wireless Application Protocol). The means for accessing the Internet service provider are well known in the prior art.

The customer sends messages to the Internet service provider (ISP) 11 identifying the website which is to be accessed by means of the URL of that website. At the ISP, a processor 17 accesses a database 13 of the ISP to find the customer profile 15 of the calling customer. The Internet service provider then accesses the requested website 21 via the Internet 5 in order to obtain the restriction rating 23 of that website. The Internet Service provider can also query an independent server which supplies rating of websites to obtain the rating of the website the end user requesting; or, the internet Service provider database can store ratings for some of websites. When this restriction rating is returned to the Internet service provider, the processor 17 compares the restriction rating of the website with the restriction requirement for the calling customer; if the restriction rating of the website is such that the restriction requirement from the customer profile would permit access (for the sake of convenience, this is being referred to as “allowable”), then the Internet service provider causes a connection to the website to be established from the ISP. A default restriction rating for a website can be a universally allowable restriction rating.

If the result of the comparison of the customer restriction requirement and the website restriction rating indicates that a connection is not allowable, the customer is informed by a message from the Internet service provider to indicate that the connection cannot be established.

An example of a set of restrictions is the rating system for motion pictures. The ratings are: G (General (for all audiences)); PG (Parental Guidance suggested); PG-13 (Parents strongly cautioned, because film contains material inappropriate for children under 13); R (Restricted to adults and to children under 17 accompanied by a parent or guardian); and NC-17 (no children under 17 admitted). This form of restriction is monotonic in the sense that each successive rating is more restrictive than the one before. A parent might restrict a child from downloading any film with a rating below (more restrictive than) PG. It is also quite possible to have a non-monotonic restriction series. For example, a new rating, V for excessive violence, could be applied to films otherwise given any rating (except, presumably G). In that case, a parent might restrict a child from downloading any film with this rating, in addition to films with a rating of R or NC-17. The invention can be used with monotonic or non-monotonic restriction requirements.

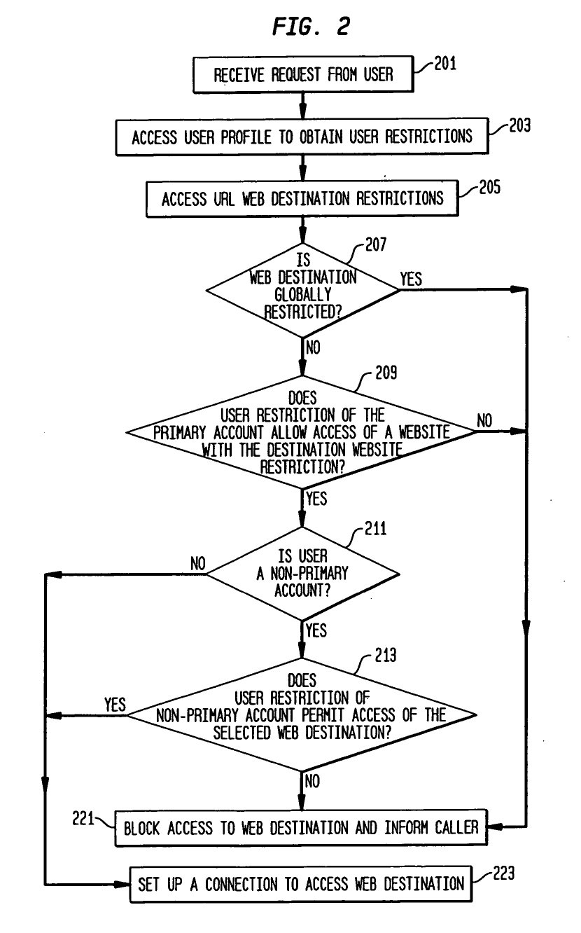

FIG. 2 is a flow diagram illustrating the operation of Applicants' invention. An Internet service provider receives a request from the user (action block 201). The request includes an identification (URL) of the website for which action is requested. The Internet service provider accesses the user profile of the requesting customer to obtain user restriction requirements for that customer (action block 203). The Internet service provider then accesses the web destination restriction rating for the requested URL (action block 205). Test 207 is used to determine whether the web destination is globally restricted. In one preferred embodiment, a list of globally restricted URLs is maintained by the Internet service provider. If so, then access to the web destination is blocked and the caller is informed (action block 221). If the web destination is not globally restricted, then test 209 is used to determine whether the user restriction requirement of the primary account of the user indicates that access to the website is allowable. If the result of test 209 indicates that it is not allowable, then action block 221, previously described, which blocks access to the web destination and informs the caller is executed. If the user restriction of the primary account does indicate an allowable access, then test 211 is used to determine whether the user is a non-primary account (for example is the account of a child or not the parent of the owner of the customer terminal). If the user is a primary account, then a connection to the web destination is established (action block 223). If the user is a non-primary account (for example, a child of the primary customer) then test 213 is used to determine whether the user restriction rating of the non-primary account allows for access to the web destination. If not, then action block 221, previously described, is executed. If access is allowed as a result of test 213, then connection is established (action block 223, previously described).

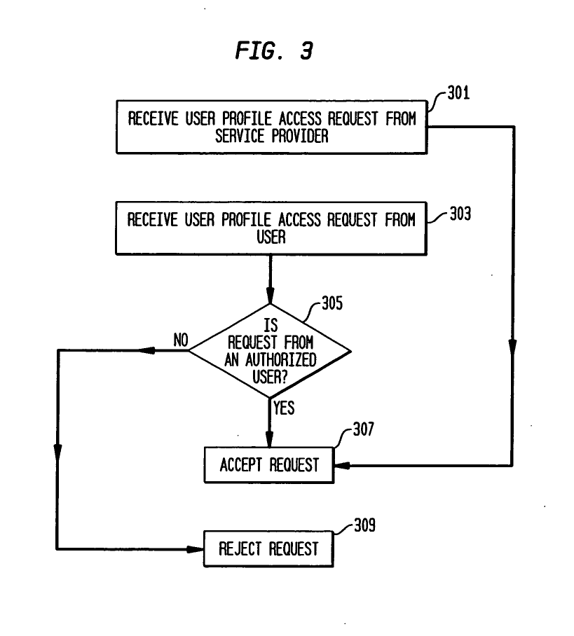

FIG. 3 is a flow diagram illustrating the operation of modifying the user profile. If a request is received to access the user profile and the request is received from the service provider (action block 301), then the access request is accepted (action block 307). This request might be made when a customer initially receives the service. If the user profile access request is received from a user (action block 303), then test 305 is used to determine whether the request is from a user authorized to access the user profile. If the request is from such an authorized user, then the request is accepted (action block 307), and the authorized user can be steered, via conventional menu methods, to enter the restriction requirement, and the identity of the user for whom the restriction requirement is to be applied in the user profile. If the request is not from an authorized user (for example, from a child in a household in which a parent has been designated as the authorized user) then the user profile access request is rejected (action block 309).

The above description is of one preferred embodiment of Applicants' invention. Other embodiments will be apparent to those of ordinary skill in the art. The invention is limited only by the attached claims.

We claim:

1. A method of filtering requests to access a website from a customer terminal comprising the steps of:
storing a customer profile for a user of said customer terminal, said customer profile comprising customer restriction requirements;
storing restriction rating data for each Uniform Resource Locator (URL) of said website;
responsive to a request received from said customer station for accessing said website, comparing said restriction requirement for said customer terminal with said restriction rating data for said website to determine whether the allowed requests from said customer station based on said customer restriction requirement permit access to said URL of said website based on restriction rating data for said website; and
responding to requests to access said website only if said customer restriction requirement data and said website restriction rating data taken together permit such access.

2. The method of claim 1 wherein a plurality of users can use said customer terminal, further comprising the steps of:
associating a different customer profile for each of said plurality of users; and
identifying one of said plurality of users making said request;
wherein the comparing step comprises the step of comparing a restriction requirement of said one of said plurality of users making said request with said restriction rating data for said website.

3. The method of claim 1 wherein said restriction requirement comprises time of day and/or day of week restrictions for modifying said restriction requirement.

4. The method of claim 1 wherein the step of responding to a request received from said customer station comprises the steps of:
comparing an identity of said website with a list of websites that are to be globally restricted; and
blocking said request if said identity of said website matches an entry in said list;
whereby access is blocked to websites considered to be undesirable by an Internet service provider for serving said customer.

5. The method of claim 1 further comprising the step of:
if said customer restriction requirement data and said website restriction rating data do not permit such access, sending a reporting message to said customer.

6. The method of claim 1 further comprising the step of:
modifying said customer profile including modifying said customer restriction data;
wherein the step of modifying comprises the step of:
checking whether a user attempting to perform said modifying step is authorized to do so.

7. Apparatus for filtering requests to access a website from a customer terminal comprising:
means for storing a customer profile for a user of said customer terminal, said customer profile comprising customer restriction requirements;
means for storing restriction rating data for each Uniform Resource Locator (URL) of said website;
means, responsive to a request received from said customer station for accessing said website, for comparing said restriction requirement for said customer terminal with said restriction rating data for said website to determine whether the allowed requests from said customer station based on said customer restriction requirement permit access to said URL of said website based on restriction rating data for said website; and
means for responding to requests to access said website only if said customer restriction requirement data and said website restriction rating data taken together permit such access.

8. The apparatus of claim 7 wherein a plurality of users can use said customer terminal, further comprising:
means for associating a different customer profile for each of said plurality of users; and
means for identifying one of said plurality of users making said request;
wherein the means for comparing comprises means for comparing a restriction requirement of said one of said plurality of users making said request with said restriction rating data for said website.

9. The apparatus of claim 7 wherein said restriction requirement comprises time of day and/or day of week restrictions for modifying said restriction requirement.

10. The apparatus of claim 7 wherein the means for responding to a request received from said customer station comprises:
means for comparing an identity of said website with a list of websites that are to be globally restricted; and
means for blocking said request if said identity of said website matches an entry in said list;
whereby access is blocked to websites considered to be undesirable by an Internet service provider for serving said customer.

11. The apparatus of claim 7 further comprising:
means, if said customer restriction requirement data and said website restriction rating data do not permit such access, for sending a reporting message to said customer.

12. The apparatus of claim 7 further comprising:
means for modifying said customer profile including modifying said customer restriction data;
wherein said means for modifying comprises means for checking whether a user attempting to perform said modifying step is authorized to do so.
